(19) United States
(12) Patent Application Publication
(10) Pub. No.: US 2007/0150817 A1
(43) Pub. Date: Jun. 28, 2007

(54) User interface and method for composing services in a ubiquitous computing environment through direction and selection operators

(76) Inventors: Nicolas B. Ducheneaut, Mountain View, CA (US); Trevor F. Smith, San Francisco, CA (US); Mark W. Newman, San Francisco, CA (US); Chris Beckmann, San Francisco, CA (US)

Correspondence Address: CASCADIA INTELLECTUAL PROPERTY, 500 UNION STREET, SUITE 1005, SEATTLE, WA, 98101, US

(21) Appl. No.: 11/317,980

(22) Filed: Dec. 23, 2005

(51) Int. Cl. G06F 17/00

(52) U.S. Cl. 715/734

(57) ABSTRACT

A user interface and method for composing services in a ubiquitous computing environment through direction and selection operators is presented. A display of a ubiquitous computing environment is presented. One or more hosts operating in the ubiquitous computing environment is represented with host symbols. Components in the ubiquitous computing environment coupled to each of the hosts are represented with one or more component symbols per host symbol. Each such component provides a service or includes a device or aggregate component. The host symbols and the component symbols are navigated in response to user inputs. A direction operator provides a focus in the display on either one of the host symbols or one of the component symbols. A selection operator performed against either one of the host symbols or one of the component symbols triggers a service- or device-oriented task comprising one of discovery, selection, connection, and control.

### FIELD

This application relates in general to ubiquitous computing environment interfacing and, in particular, to a user interface and method for composing services in a ubiquitous computing environment through direction and selection operators.

### BACKGROUND

Highly interconnected and widely distributed networking environments are becoming increasingly pervasive. Network infrastructures have become almost commonplace, with access points widely available in workplaces, homes, and public venues, such as libraries, malls, and coffeehouses. Network infrastructures are even available to travelers and commuters through wide area wireless services, such as WiMax and digital cellular networks.

A rich set of devices and services have now been made available by these distributed networking environments. Services include, for instance, data exchange, such as digital music download, interactive computer gaming, and conventional file sharing. To some extent, the devices available are driven by the services offered. For example, speakers or headphones are needed to listen to downloaded digital music and a gaming console may be required to participate in interactive computer gaming. Similarly, computer systems and application programs are needed access or store conventional files.

This combination of highly distributed and heterogeneous services and devices is known as “ubiquitous computing.” Activities in the ubiquitous computing paradigm center around service composition, which includes discovering services and devices available over the network, selecting a subset of desired services and devices, and connecting and controlling the selected subset. Accessing a single service is trivial, but access complexity rapidly increases as the range of combinable services and attendant devices also increase. The services can offer varied and widely diverging capabilities, and the number of services can potentially be quite large.

The richness of a ubiquitous computing environment can pose challenges to users in composing services. Ideally, the users should remain unaware of or be kept insulated from compatibility and interfacing issues at the device implementation level. Similarly, the users should not be mislead into assuming interconnectedness between disparate devices or services when a physical connection is not possible.

Locating suitable devices and services can be tedious and at odds with the goals of encapsulating implementation and physical interconnectivity details. Hosts, for instance, can offer assorted resources and capabilities through attached components. As needed, these resources and capabilities can be formed into a nested hierarchy that requires expanding and searching through successively detailed levels. Finding a device or service can potentially require extensive searching, which must be coupled with an ability to backtrack through the search space to resume searching at an earlier point. Nevertheless, the capabilities of available input devices vary widely and are typically limited to providing a minimal number of keys tied to performing a specific function. Ubiquitous computing environments often rely on mobile devices, such as cellular phones or “smart” watches, or simple end-user control devices, for instance, remote controllers for television or stereos. These devices have limited inputs, such as “jog” dials or a small set of keys that only allow direction and selection operations. Key sequences or combinations can sometimes be used to access further functions or extended character sets on these devices, but such solutions can be tedious and device-dependent.

Hierarchical menu navigational interfaces are widely used. A series of selections or parameters are provided in a tree-like structure, which is naturally intuitive and user friendly. Generally, hierarchical menus are offered for a specific device, such as a network service host that provides a library of media content. However, this model assumes that the device is tied to a particular service and the menu is limited to selecting a single “end point,” which is typically a target data source or destination. Support for interfacing to a device over a network infrastructure is not provided and the user must resort to manual means to locate, provision, and control distributed heterogeneous devices.

Therefore, there is a need for an approach to providing a flexible and simple user input interface for supporting service composition in a ubiquitous computing environment. Preferably, such an approach would support widely-distributed heterogeneous hosts, devices, and aggregates in a networked configuration using a minimal set of user operations.

### SUMMARY

One embodiment provides a user interface and method for composing services in a ubiquitous computing environment through direction and selection operators. A display of a ubiquitous computing environment is presented. One or more hosts operating in the ubiquitous computing environment is represented with host symbols. Components in the ubiquitous computing environment coupled to each of the hosts are represented with one or more component symbols per host symbol. Each such component provides a service or includes a device or aggregate component. The host symbols and the component symbols are navigated in response to user inputs. A direction operator provides a focus in the display on either one of the host symbols or one of the component symbols. A selection operator performed against either one of the host symbols or one of the component symbols triggers a service- or device-oriented task comprising one of discovery, selection, connection, and control.

A further embodiment provides a user interface and method for composing hierarchically-structured services in a ubiquitous computing environment through direction and selection operators. A graphical display of a ubiquitous computing environment is presented. One or more hosts operating in the ubiquitous computing environment are represented with graphical host symbols. Components in the ubiquitous computing environment coupled to each of the hosts are represented with one or more graphical component symbols connected to each graphical host symbol. Each such component provides a service or includes a device or aggregate component. Each such aggregate component includes a plurality of components. The graphical host symbols and the graphical component symbols are hierarchically navigated in response to user inputs. A direction operator provides a focus in the display on either one of the graphical host symbols or one of the graphical component symbols. A selection operator performed against either one of the graphical host symbols or one of the graphical component symbols triggers a service- or device-oriented task. The service- or device-oriented task is performed and includes one of discovery, selection, connection, and control.

Still other embodiments of the present invention will become readily apparent to those skilled in the art from the following detailed description, wherein are described embodiments by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing, by way of example, devices and components in a ubiquitous computing environment.

FIG. 2 is a process flow diagram showing a method for composing services in a ubiquitous computing environment through direction and selection operators, in accordance with one embodiment.

FIG. 3 is a state diagram showing discovery operations in the ubiquitous computing environment of FIG. 1.

FIG. 4 is a state diagram showing selection and connection operations in the ubiquitous computing environment of FIG. 1.

FIG. 5 is a state diagram showing control operations in the ubiquitous computing environment of FIG. 1.

FIG. 6 is a diagram showing, by way of example, a user interface for composing services in a ubiquitous computing environment through direction and selection operators, in accordance with one embodiment.

FIG. 7 is a diagram showing, by way of example, stacked components displayed in a user interface of FIG. 6.

FIGS. 8 and 9 are diagrams respectively showing, by way of example, an aggregate component displayed in user interfaces of FIG. 6 prior to and following selection.

FIG. 10 is a diagram showing, by way of example, a selection of an initial component displayed in a user interface of FIG. 6.

FIGS. 11 and 12 are diagrams showing, by way of example, a selection of a subsequent component displayed in user interfaces of FIG. 6.

### DETAILED DESCRIPTION

Ubiquitous Computing Environment

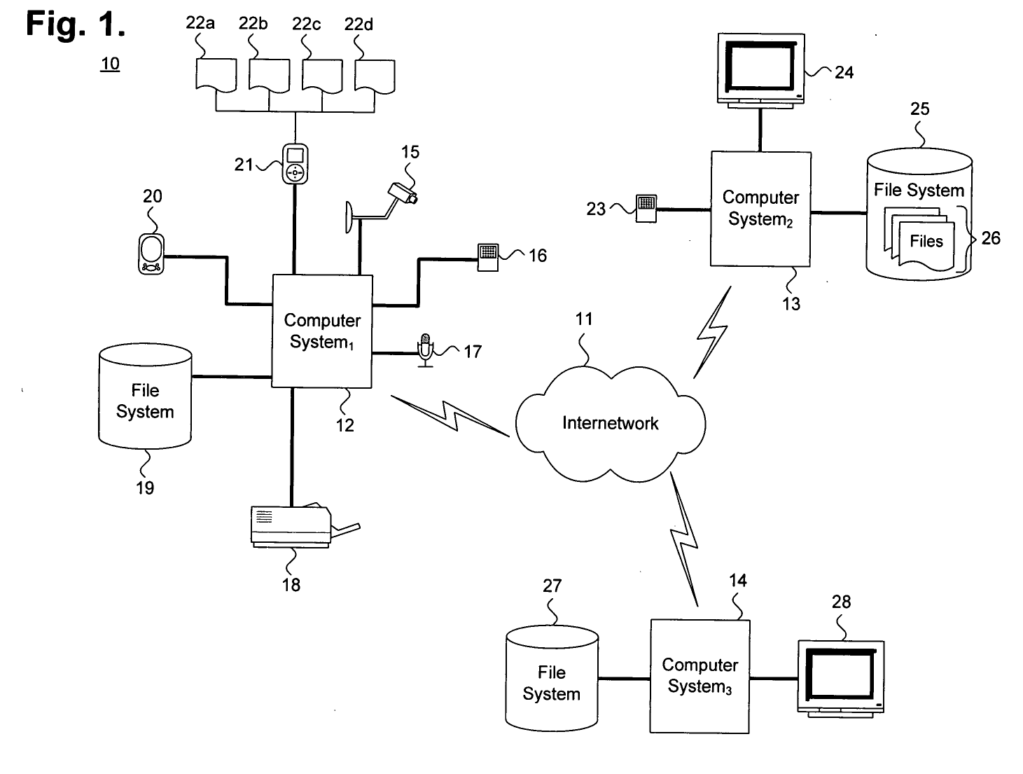

A ubiquitous computing environment is characterized by highly distributed and heterogeneous services and devices interconnected via a network infrastructure. FIG. 1 is a block diagram showing, by way of example, devices and components in a ubiquitous computing environment 10. The environment 10 includes one or more hosts, which can include computer systems 12, 13, 14. Other hosts are possible, including servers, micro programmed controllers, and intelligent network switches. The hosts are interconnected over via network infrastructure, such as an internetwork 11, including the Internet. All of the hosts need not be connected to the same network and combinations of disparate networks are possible. In one embodiment, the network is a Transmission Control Protocol/Interface Protocol (TCP/IP) compliant network that directly supports IEEE 802.3 (“Ethernet”) and 802.11 (“WiFi”) standard interconnections. The network can also provide gateways to external networks. Other types, configurations, and arrangements of networks are possible.

Each host is coupled to one or more components, which include aggregate and terminal components, and the host enables the components to be available over the network. Several components can be attached to a single host. An aggregate component is a combination of two or more components, which can also include nested aggregate components. For instance, the computer system 12 includes seven components, which include video camera 15, speaker 16, microphone 17, printer 18, file system 19, personal data assistant 20, and personal media player 21, which is an aggregate component. The personal media player 21 further includes individual media files 22a-d. Similarly, the computer system 13 includes a speaker 23, video display 24, and file system 25, which is also an aggregate component. The file system 25 further includes individual data files 26. Finally, the computer system 14 includes a file system 27 and video display 28. Other components are possible.

Each component, including aggregate components, can function as a data source or data sink, either separately or in combination. A data source provides data, whereas a data sink consumes data. For example, the video camera 15 and microphone 17 are data sources, whereas the speakers 16 and 23, video displays 24 and 28, and printer 18 are data sinks. The remaining components can function as both data sources and data sinks.

The hosts and components form a hierarchy of nodes within the environment. Each host forms the root of each node and the components form the individual leaves. Aggregate components form intermediate levels within the hierarchy, while non-aggregate components form terminal leaves. Other forms of host and component structuring are possible, although hierarchical structuring is intuitive and user friendly.

Services are provided through the components, including aggregate components. The components can also be treated as devices that perform a set of predefined services. For instance, playing music is a service, while a speaker is a particular type of device for playing music, among other functions. Generally, the devices available within a given environment 10 are driven to some extent by the services offered, although a richer set of devices could be provided, even if not all of the services utilize the available devices. Similarly, a richer set of services could be offered, even if not all of the devices support the available services.

In one embodiment, the hosts and components are interconnected using the Obje interoperability framework, which provides a set of scaleable and extensible interface elements that enable digital devices and services to interoperate over both wired and wireless networks, such as described in Black J. A. et al., “Speakeasy: A Platform for Interactive Public Displays,” ACM Conf. on Computer-Supported Cooperative Work (CSCW 2002), New Orleans, LA, Nov. 16, 2002; Edwards W. K. et al., “The Case for Recombinant Computing,” Xerox PARC Tech. Report CSL-01-1 (April 2001); and “Obje™ Interoperability Framework,” a white paper available at

http://www.parc.com/research/proiects/obje/Obie_Whitepaper.pdf, Xerox PARC (2003), the disclosures of which are incorporated by reference. Other forms of interconnection are possible.

Method

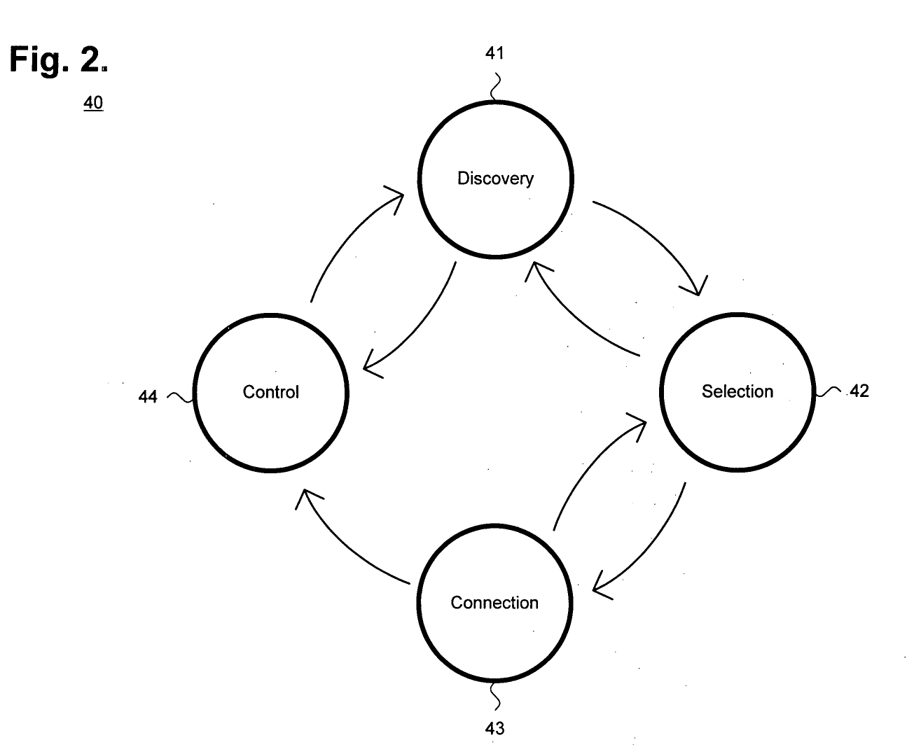

Service composition is provided in response to user interactions conveyed through a user interface. FIG. 2 is a process flow diagram showing a method 40 for composing services in a ubiquitous computing environment 10 through direction and selection operators, in accordance with one embodiment. As used herein, service composition includes the discovery, selection, connection, and control of both services and devices over the network, except as noted.

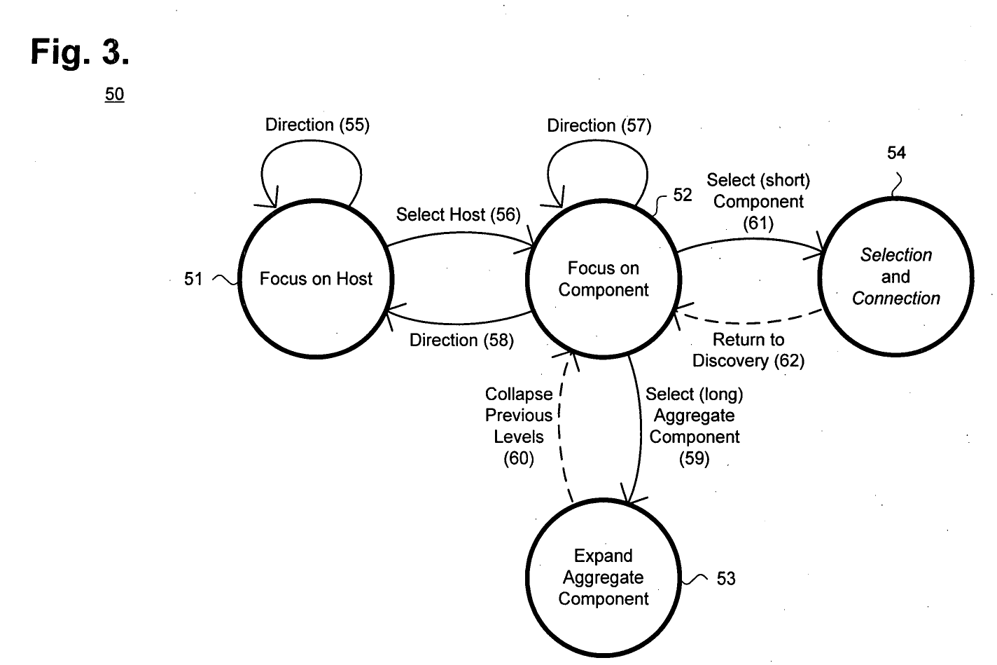

Four basic tasks must be provided to support service composition, which include discovery 41, selection 42, connection 43, and control 44. In one embodiment, these tasks are performed through two user-performable operators: direction and selection. Discovery 41 allows a user to browse the lists of available hosts and each host's list of attached components, such as further described below with reference to FIG. 3. Discovery 41 also enables a user to expand aggregate components, which “encapsulate” one or more further components, to an arbitrary level. Finally, discovery 41 permits a user to backtrack and resume navigation at a previous level, such as where a desired service or device cannot be found on a particular host.

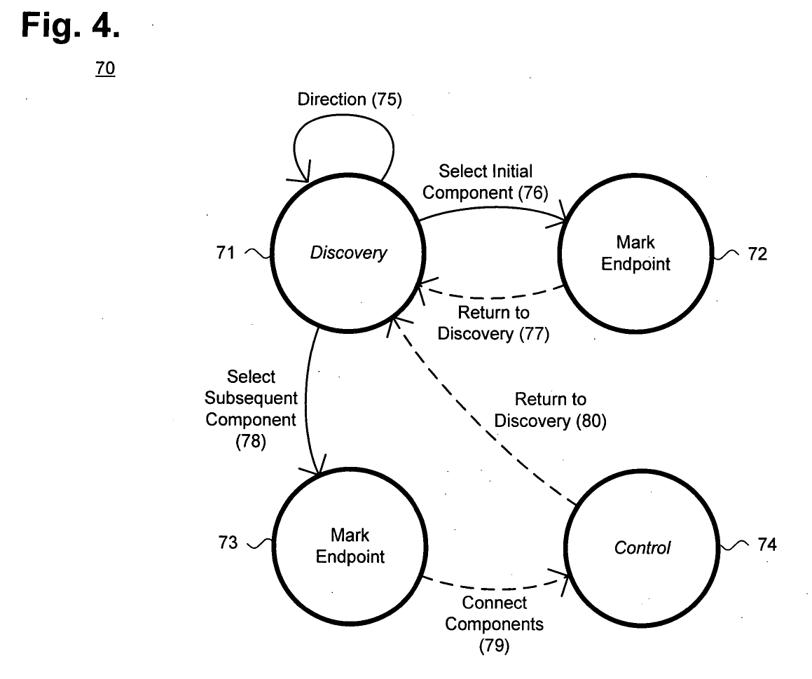

Selection 42 allows a user to designate a particular component to serve as a data source or data sink, such as further described below with reference to FIG. 4. At least one data source and at least one data sink must be designated to form a connection. Selection 42 identifies the end points of a connection and the data sources and data sinks can be picked in any order. In one embodiment, the selection of an initial component causes any other component that is incompatible and not connectable to the initial component to be logically “removed” from the set of components displayed in the user interface. Each removed component is displayed as a grayed-out symbol that is also skipped during subsequent component selection. Thus, the user is insulated from compatibility and interfacing issues at the device implementation level. Selection 42 overlaps with discovery 41, which allows a user to find initial and subsequently connectable components.

Connection 43 provides the physical interconnectivity of the components at the selected end points, such as further described below with reference to FIG. 4. Connection is triggered by the selection 42 of a terminal end point, that is, a component that allows delivery of the service or operation of the device. For example, a speaker is a terminal end point to a service that plays music. Connections are not limited to one-to-one pairings of data sources and data sinks. A data source could be paired with a plurality of data sinks, such as when playing music through multiple sets of speakers. Similarly, a data sink could be paired with a plurality of data sources, such as when mixing multiple video feeds into a single video display. Lastly, multiple data sources could be paired with multiple data sinks, such as when the multiple video feeds include both video and audio data that must be respectively played on a video display and speakers. Connection 43 overlaps with discovery 41 and selection 42, which respectively allow a user to find and choose a terminal end points.

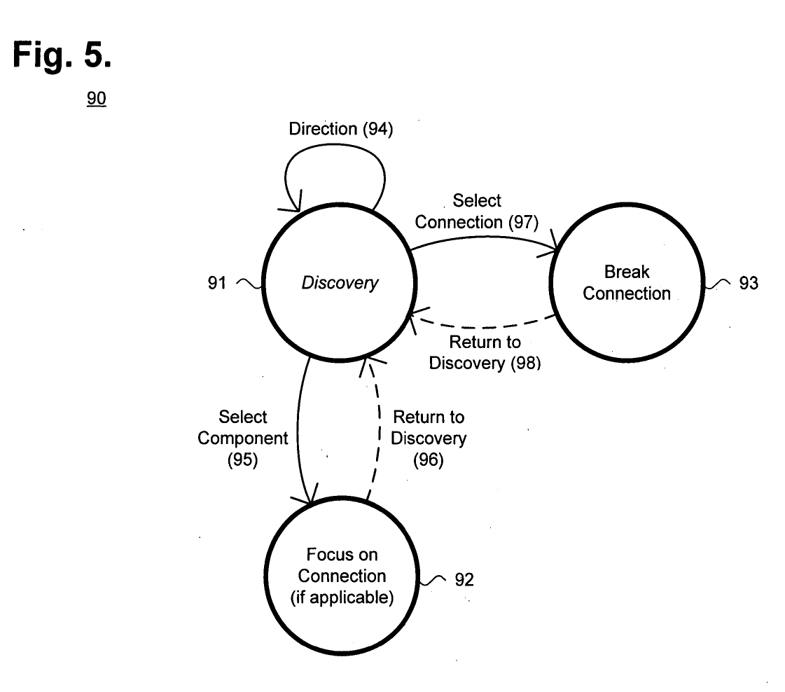

Finally, control 44 enables a user to monitor and sever active connections, such as further described below with reference to FIG. 5. Control 44 overlaps with discovery 41 and selection 42, which respectively allow a user to find and choose a target connection. Other service composition operations are possible.

State Diagrams

Service composition is provided through the user interface through a set of overlapping states that are navigated using the direction and selection operators. In one embodiment, the direction operator provides bidirectional rotation, although other forms of movement, including spherical, linear, and planar are possible. The selection operator provides a toggle movement, which can be of short or long duration, although other forms of movement are possible. Moreover, the direction and selection operators can be supplemented with various forms of feedback, including tactile and audible feedback. An example of a physical controller suitable for implementing the direction and selection operators is the PowerMate USB Multimedia Controller and Input Device, sold by Griffin Technology, Inc., Nashville, Tenn., which is an assignable and programmable controller that provides a rotary knob to enable both bi-directional rotary motion for direction and push-button motion for selection.

Service composition begins with discovery. FIG. 3 is a state diagram showing discovery operations 50 in the ubiquitous computing environment 10 of FIG. 1. By default, service composition begins in discovery with a initial focus on an arbitrary host (state 51), although the initial focus could also be on an arbitrary component or left unspecified. The direction operator (transition 55) shifts the focus over each successive host (state 51) in the environment 10 before returning the host originally in the initial focus (state 51). The selection operator (transition 56) shifts the focus to one of the components (state 52) coupled to the host in the focus (state 51).

Within the set of components coupled to the host, the direction operator allows the user to shift the focus to each successive component (transition 57) and to return the focus back to the host (transition 58), thereby allowing the user to backtrack to resume discovery at an earlier point. The selection operator is bimodal. If the user performs the selection operator with a long duration movement while the focus is on an aggregate component (transition 59), the constituent components within the aggregate component are expanded within the display (state 53). If the component in the focus is itself an aggregate component (state 52), any previous levels within the hierarchy are automatically collapsed (transition 60) to limit the display to two levels of depth. Alternately, if the user performs the selection operator with a short duration movement (transition 61), service composition shifts to selection and connection (state 54), after which service composition returns to discovery (transition 62).

FIG. 4 is a state diagram showing selection and connection operations 70 in the ubiquitous computing environment 10 of FIG. 1. The direction operator (transition 75) returns to discovery (state 71). The selection operator is context dependent. If the user performs the selection operator to select an initial component (transition 76), a first end point for a connection is marked (state 72), after which service composition returns to discovery (transition 77). Alternately, if the user performs the selection operator to select a subsequent component (transition 78), a subsequent end point for an incomplete connection is marked (state 73) and connection is made, assuming a one-to-one or one-to-many pairing. Many-to-many pairings are also possible. Service composition then shifts (transition 79) to control (state 74), after which service composition returns to discovery (transition 80).

FIG. 5 is a state diagram showing control operations 90 in the ubiquitous computing environment 10 of FIG. 1. The direction operator (transition 94) returns to discovery (state 91). The selection operator is bimodal. If the user performs the selection operator while the focus is on a component (transition 95), the focus shifts to any connection that is applicable, that is, in which the selected component is an end point (state 92). If the user performs the selection operator while the focus in on a connection (transition 92), the connection is broken (state 93), after which service composition returns to discovery (transition 98). Other states and transitions are possible.

User Interface

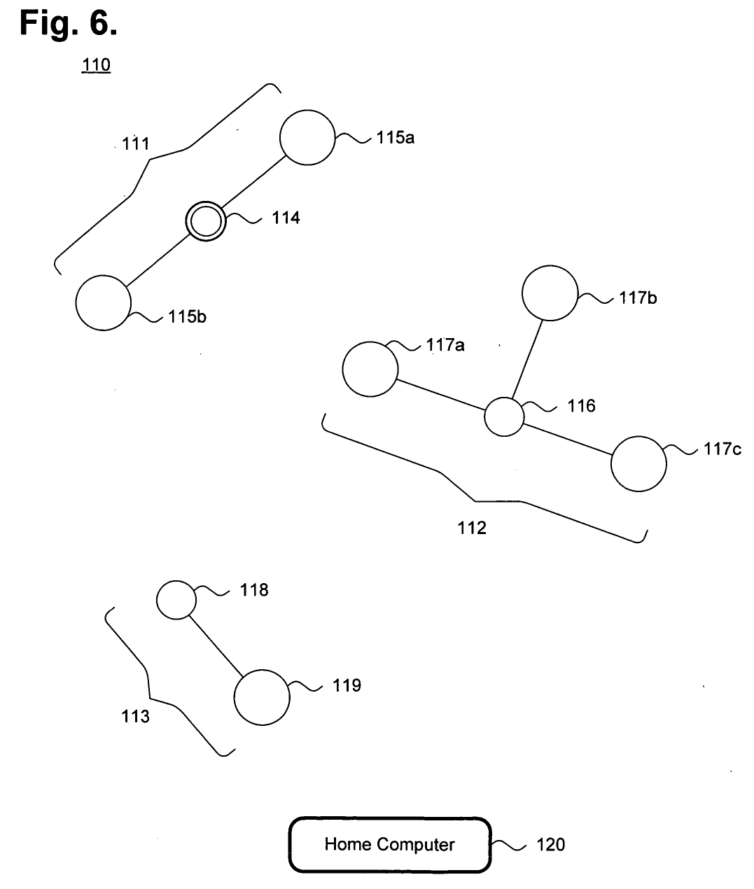

The user interface for service composition can be implemented on a host, component, or other mechanism that is able to communicatively interface with the hosts and components in the ubiquitous computing environment 10. FIG. 6 is a diagram showing, by way of example, a user interface 110 for composing services in a ubiquitous computing environment 10 through direction and selection operators, in accordance with one embodiment. The user interface provided for service composition assumes that user inputs are limited to the direction and selection operators, but also relies upon a graphical display for user output. Additional operators could also be provided.

The user interface 110 is loosely based on a “ball and stick” metaphor. Collections 111, 112, 113 of hosts and their coupled components are arranged with the host at the center and the components placed at equal distances around the host. Each host is represented by a host symbol 113, 116, 118. The components coupled to each host are represented by component symbols 115a-b, 117a-c, 119 respectively connected by lines to the host symbols 113, 116, 118. The focus is indicated by highlighting and an explanatory label in an explorer bar 120. For example, a focus on host symbol 114 corresponds to the explanatory label “Home Computer.” In a further embodiment, the host and component symbols could be replaced by icons, graphical symbols, shapes, or textual labels, as well as other forms, colors, and descriptions for the underlying host or component. Other user interface metaphors are possible.

Stacked Components

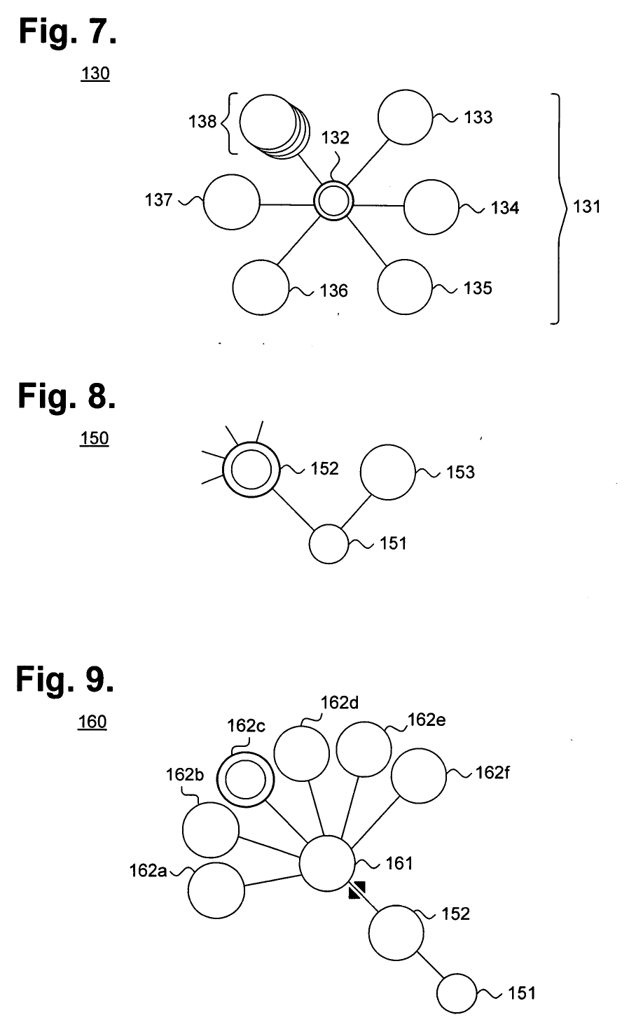

To maintain clarity of presentation, the number of component symbols allowed to be placed around a host symbol is limited. FIG. 7 is a diagram showing, by way of example, stacked components 138 displayed in a user interface 130 of FIG. 6. A host and components collection 131 includes a host symbol 132, currently in focus, and connected host symbols 133-138. A maximum of six component symbols are allowed to “orbit” the host symbol, although other limits, including minimum symbol counts, are possible. The host represented by the host symbol 132 has more than six coupled components. Accordingly, individual component symbols 133-137 are displayed for five of the components and the component symbols for the remaining components are represented by a stacked component symbol 138. The direction operator successively shifts the focus over each successive individual component symbol 133-137 until the stacked component symbol 138 is encountered. The focus then remains on the stacked component symbol 138, while one of the individual component symbols 133-137 is removed from view and a previously-hidden component symbol is displayed at the top of the “stack.”

Aggregate Components

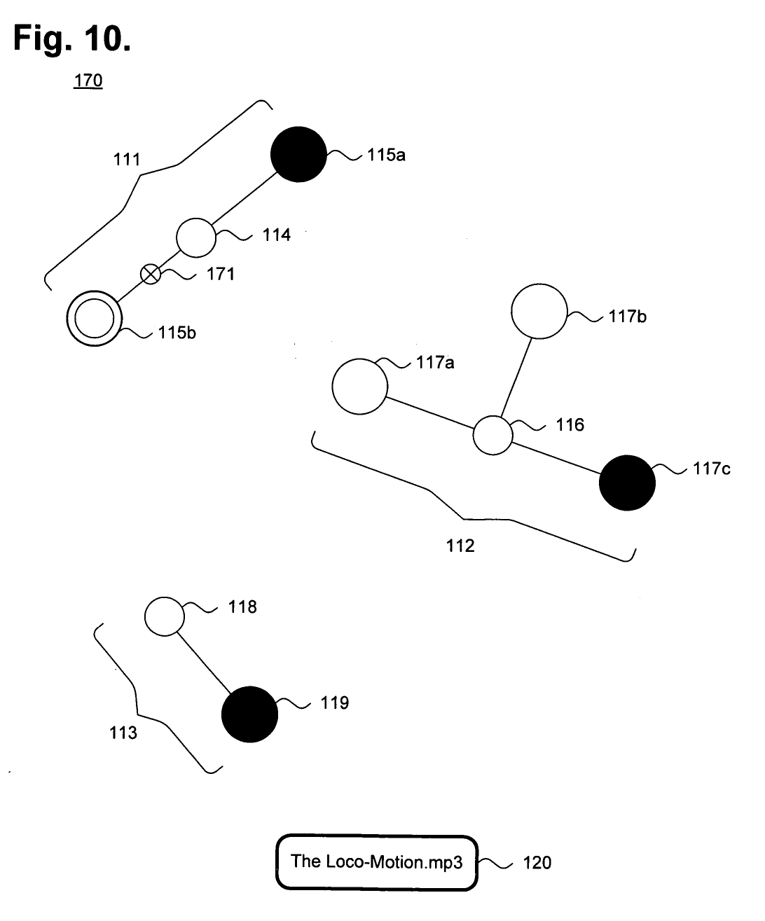

An aggregate component is a combination of two or more components, which can also include nested aggregate components. FIGS. 8 and 9 are diagrams respectively showing, by way of example, an aggregate component displayed in user interface 150, 160 of FIG. 6 prior to and following selection. Referring first to FIG. 8, a host symbol 151 is connected to an aggregate component symbol 152, currently in focus, and a non-aggregate component symbol 153. To maintain clarity of presentation, each component symbol that represents an aggregate component is marked by “tendrils” or other indicia that allows the aggregate component symbol 152 to be displayed in place with other non-aggregate component symbols 153.

Referring next to FIG. 8, executing the selection operator with a long duration movement while the focus is on an aggregate component symbol 152 triggers the expansion and display of the constituent component symbols 162a-f. The original aggregate component symbol 152 remains in place while a duplicate aggregate component symbol 161 anchors the constituent component symbols 162a-f, which can be explored using the direction and selection operators. In one embodiment, if the original aggregate component symbol 152 was itself a constituent component symbol of an aggregate component symbol, any previously displayed levels within the hierarchy are automatically collapsed to limit the display to two levels of depth.

Component Selection, Connection, and Control

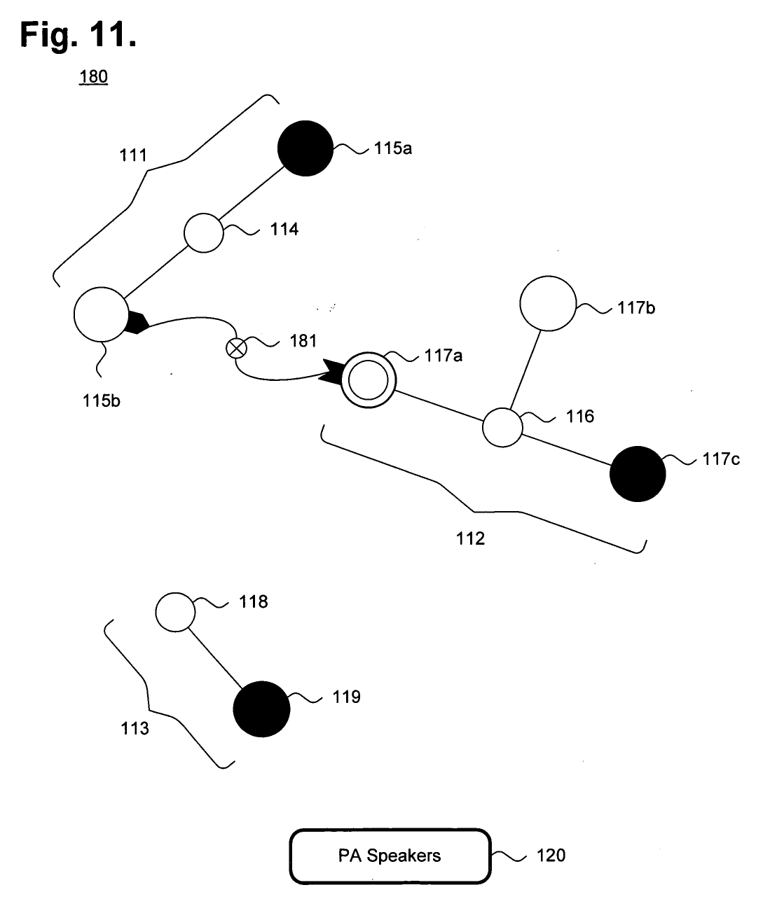

To insulate users from compatibility and interfacing issues at the device implementation level, the component symbols that represent incompatible and unconnectable components are logically “removed” from the set of component symbols displayed in the user interface following the selection of an initial component. FIG. 10 is a diagram showing, by way of example, a selection of an initial component displayed in a user interface 170 of FIG. 6. The component symbol 115b that represents a service component coupled to the host represented by the host symbol 114 is currently in focus with an explanatory label “The Loco-Motion.mp3” displayed in the explorer bar 120. Upon selection, a control point 171 is added to the line that connects the component symbol 115b to the host symbol 114. The control point 171 can subsequently be selected to de-select the component symbol 115b. In addition, the component symbols 115a, 117a, 119 are grayed-out to indicate that the components represented are either incompatible with or unconnectable to the service component represented by component symbol 115b. Moreover, during discovery, the direction operator skips over these component symbols 115a, 117a, 119, thereby removing the component symbols from further consideration by the user.

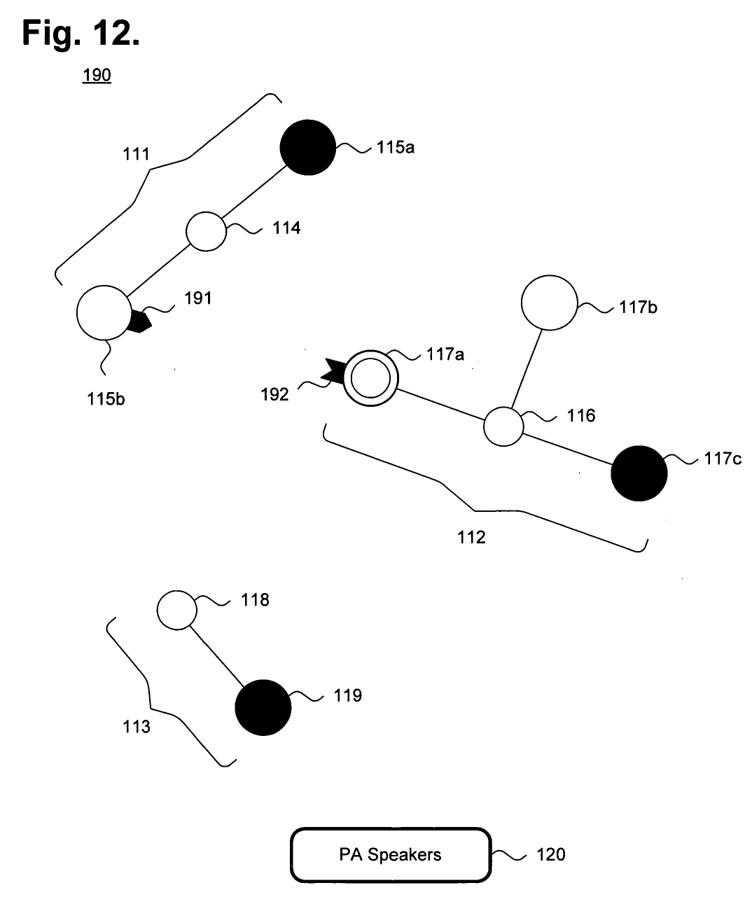

Visually, connection takes place in two stages. FIGS. 11 and 12 are diagrams showing, by way of example, a selection of a subsequent component displayed in user interfaces 170, 180 of FIG. 6. Referring first to FIG. 11, the component symbol 117a that represents a device component coupled to the host represented by the host symbol 116 is currently in focus with an explanatory label “PA Speakers” displayed in the explorer bar 120. Upon selection, a wavy line with a control point 181 briefly connects the component symbols 115b, 117a that constitute the end points of a connection. The control point 181 can subsequently be selected to disconnect the components represented by the component symbols 115b, 117a. Referring next to FIG. 12, the wavy line is no longer displayed, leaving only a set of receptor symbols 191, 192 to mark the end points of the connection. A data source receptor symbol 191 indicates the data source and a data sink receptor symbol 192 indicates the data sink. During discovery, the wavy line with the control point 181 again reappears upon selection of either of the component symbols 115b, 117a to allow control of the connection.

While the invention has been particularly shown and described as referenced to the embodiments thereof, those skilled in the art will understand that the foregoing and other changes in form and detail may be made therein without departing from the spirit and scope.

What is claimed is:

1. A user interface for composing services in a ubiquitous computing environment through direction and selection operators, comprising:
a display of a ubiquitous computing environment, comprising:
host symbols to represent one or more hosts operating in the ubiquitous computing environment; and
one or more component symbols per host symbol to represent components in the ubiquitous computing environment coupled to each of the hosts, each such component providing a service or comprising a device or aggregate component; and
controls to navigate through the host symbols and the component symbols in response to user inputs, comprising:
a direction operator to provide a focus in the display on either one of the host symbols or one of the component symbols; and
a selection operator performed against either one of the host symbols or one of the component symbols to trigger a service- or device-oriented task comprising one of discovery, selection, connection, and control.

2. A user interface according to claim 1, wherein a discovery task is triggered in response to operation of at least one of the direction operator and the selection operator on one such host symbol or one such component symbol that represents a component comprising an aggregate component.

3. A user interface according to claim 1, wherein a selection task is triggered in response to operation of the selection operator on one such component symbol that represents a providing a service or comprising a device.

4. A user interface according to claim 3, wherein each remaining component symbol in the display that represents a component not compatible with the one such component is logically removed upon the triggering of a selection task for one such component.

5. A user interface according to claim 4, wherein each remaining component symbol is logically removed by at least one of deemphasizing the remaining component symbol and disabling the focus on the remaining component symbol.

6. A user interface according to claim 3, wherein a connection task is triggered for one or more of the remaining components upon the triggering of a selection task for one such component.

7. A user interface according to claim 6, wherein a control task is triggered for the connected components upon the triggering of a connection task for one or more such connected components.

8. A user interface according to claim 1, wherein the direction operator operates in at least one of a rotational, spherical, linear, and planar direction.

9. A method for composing services in a ubiquitous computing environment through direction and selection operators, comprising:
presenting a display of a ubiquitous computing environment, comprising:
representing one or more hosts operating in the ubiquitous computing environment with host symbols; and
representing components in the ubiquitous computing environment coupled to each of the hosts with one or more component symbols per host symbol, each such component providing a service or comprising a device or aggregate component; and
navigating through the host symbols and the component symbols in response to user inputs, comprising:
responding to a direction operator to provide a focus in the display on either one of the host symbols or one of the component symbols; and
responding to a selection operator performed against either one of the host symbols or one of the component symbols to trigger a service- or device-oriented task comprising one of discovery, selection, connection, and control.

10. A method according to claim 9, further comprising:
triggering a discovery task in response to operation of at least one of the direction operator and the selection operator on one such host symbol or one such component symbol that represents a component comprising an aggregate component.

11. A method according to claim 9, further comprising:
triggering a selection task in response to operation of the selection operator on one such component symbol that represents a providing a service or comprising a device.

12. A method according to claim 11, further comprising:
upon the triggering of a selection task for one such component, logically removing each remaining component symbol in the display that represents a component not compatible with the one such component.

13. A method according to claim 12, wherein each remaining component symbol is logically removed by at least one of deemphasizing the remaining component symbol and disabling the focus on the remaining component symbol.

14. A method according to claim 11, further comprising:
upon the triggering of a selection task for one such component, triggering a connection task for one or more of the remaining components.

15. A method according to claim 14, further comprising:
upon the triggering of a connection task for one or more such connected components, triggering a control task for the connected components.

16. A method according to claim 9, wherein the direction operator operates in at least one of a rotational, spherical, linear, and planar direction.

17. A computer-readable storage medium holding code for performing the method according to claim 9.

18. A user interface for composing hierarchically-structured services in a ubiquitous computing environment through direction and selection operators, comprising:
a graphical display of a ubiquitous computing environment, comprising:
graphical host symbols to represent one or more hosts operating in the ubiquitous computing environment; and
one or more graphical component symbols connected to each graphical host symbol to represent components in the ubiquitous computing environment coupled to each of the hosts, each such component providing a service or comprising a device or aggregate component, each such aggregate component comprising a plurality of components;
controls to hierarchically navigate through the graphical host symbols and the graphical component symbols in response to user inputs, comprising:
a direction operator to provide a focus in the display on either one of the graphical host symbols or one of the graphical component symbols; and
a selection operator performed against either one of the graphical host symbols or one of the graphical component symbols to trigger a service- or device-oriented task; and
a processor to perform the service- or device-oriented task comprising one of discovery, selection, connection, and control.

19. A user interface according to claim 18, wherein the graphical component symbols are arranged around the graphical host symbol that represents the host to which the components represented by the graphical component symbols are coupled.

20. A user interface according to claim 18, further comprising:
a limit on a number of the graphical component symbols connected to each such graphical host symbol, wherein the graphical component symbols in excess of the number are logically stacked.

21. A user interface according to claim 18, wherein the graphical component symbols for each of the plurality of components comprising the aggregate component are displayed upon the triggering of a selection task for one such aggregate component.

22. A user interface according to claim 18, wherein one or more of the graphical host symbols and the graphical component symbols are displayed as an icon, graphical symbol, shape, or textual label.

23. A method for composing hierarchically-structured services in a ubiquitous computing environment through direction and selection operators, comprising:
presenting a graphical display of a ubiquitous computing environment, comprising:
representing one or more hosts operating in the ubiquitous computing environment with graphical host symbols; and
representing components in the ubiquitous computing environment coupled to each of the hosts with one or more graphical component symbols connected to each graphical host symbol, each such component providing a service or comprising a device or aggregate component, each such aggregate component comprising a plurality of components;
hierarchically navigating through the graphical host symbols and the graphical component symbols in response to user inputs, comprising:
responding to a direction operator to provide a focus in the display on either one of the graphical host symbols or one of the graphical component symbols; and
responding to a selection operator performed against either one of the graphical host symbols or one of the graphical component symbols to trigger a service- or device-oriented task; and
performing the service- or device-oriented task comprising one of discovery, selection, connection, and control.

24. A method according to claim 23, further comprising:
arranging the graphical component symbols around the graphical host symbol that represents the host to which the components represented by the graphical component symbols are coupled.

25. A method according to claim 23, further comprising:
limiting a number of the graphical component symbols connected to each such graphical host symbol; and
logically stacking the graphical component symbols in excess of the number.

26. A method according to claim 23, further comprising:
upon the triggering of a selection task for one such aggregate component, displaying the graphical component symbols for each of the plurality of components comprising the aggregate component.

27. A method according to claim 23, further comprising:
displaying one or more of the graphical host symbols and the graphical component symbols as an icon, graphical symbol, shape, or textual label.

28. A computer-readable storage medium holding code for performing the method according to claim 23.
